(19) United States
(12) Patent Application Publication
(10) Pub. No.: US 2024/0272647 A1
(43) Pub. Date: Aug. 15, 2024

(54) AUTOMATIC SWIMMING POOL CLEANER WITH AUTO-SCHEDULING SYSTEMS AND METHODS

(71) Applicant: ZODIAC POOL CARE EUROPE, Belberaud (FR)

(72) Inventor: Simon Duffaut, Castelginest (FR)

(73) Assignee: ZODIAC POOL CARE EUROPE, Belberaud (FR)

(21) Appl. No.: 18/439,424

(22) Filed: Feb. 12, 2024

Related U.S. Application Data
(60) Provisional application No. 63/445,273, filed on Feb. 13, 2023.

(51) Int. Cl. G05D 1/648; E04H 4/16; G05D 1/221; G05D 1/467; G05D 105/10; G05D 107/00; G05D 111/60

(52) U.S. Cl. CPC G05D 1/648; E04H 4/1654; G05D 1/221; G05D 1/467; G05D 2105/10; G05D 2107/29; G05D 2111/60

(57) ABSTRACT

Automatic swimming pool cleaners for swimming pools and spas may automatically schedule, defined, and/or plan a future cleaning cycle for the automatic swimming pool cleaner. The automatic swimming pool cleaner itself may plan the future cleaning cycle without receiving a cleaning order from a user and/or may allow for the pool system to keep the pool or spa clean by itself without relying on an order from the user as traditionally required.

### REFERENCE TO RELATED APPLICATION

This application claims the benefit of U.S. Provisional Patent Application No. 63/445,273, filed on Feb. 13, 2023, and entitled AUTO-SCHEDULING SYSTEMS AND METHODS FOR AUTOMATIC SWIMMING POOL CLEANER, the content of which is hereby incorporated by reference in its entirety.

### FIELD OF THE INVENTION

The invention relates to systems and apparatuses for cleaning water-containing vessels such as swimming pools and spas and more particularly, although not necessarily exclusively, to automatic swimming pool cleaners (APCs).

### BACKGROUND OF THE INVENTION

Numerous cleaning devices capable of autonomous movement within swimming pools and spas currently exist. The most common of these devices are APCs, which often are either hydraulic or robotic in type. Hydraulic cleaners vary water flow for movement, while robotic cleaners typically employ electric motors to cause motion. Hydraulic APCs, furthermore, subdivide into “pressure-side” and “suction-side” cleaners, with pressure-side cleaners being fluidly connected to outputs of pumps of pool water circulation systems and suction-side cleaners being fluidly connected to inputs of such pumps.

Currently, APCs perform cleaning cycles after receiving an order from a user through a button, a remote, an application, or a scheduler (set previously by the user). Traditional reliance on a user to perform cleaning cycles makes the pool susceptible to quality issues if a user forgets to initiate a cleaning cycle, lacks an understanding of proper pool maintenance and unsuitably initiates cleaning cycles, etc.

### SUMMARY

Embodiments covered by this patent are defined by the claims below, not this summary. This summary is a high-level overview of various embodiments and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

According to certain embodiments, a method of automatically scheduling cleaning cycles for an APC includes analyzing, by the APC, input related to a pool system, and defining, by the APC, a future cleaning cycle comprising a trigger as a cycle parameter based on the input.

According to various embodiments, a method of automatically scheduling cleaning cycles for an APC includes defining a future cleaning cycle comprising at least one cycle parameter. In various embodiments, the at least one cycle parameter of the future cleaning cycle is defined based on one or more inputs about a pool system and/or the APC.

According to some embodiments, a method includes automatically scheduling a future cleaning cycle for an APC without receiving a cleaning order from a user.

According to certain embodiments, a method includes defining a future cleaning cycle based on one or more inputs, and the one or more inputs include one or more of a date from a last cleaning cycle, a weather forecast, user feedback about the last cleaning cycle, pool dirtiness, pool dimensions, pool shape, pool material, filter status, motor energy consumption, a future pool usage, or battery capacity, and wherein defining the future cleaning cycle comprises defining one or more of a trigger for starting the future cleaning cycle, a date, a cycle duration, a cleaning pattern, or a trigger for ending the future cleaning cycle.

According to various embodiments, an APC for a swimming pool or spa includes a controller for automatically defining a future cleaning cycle for the APC without receiving a cleaning order from a user.

According to some embodiments, an APC for a swimming pool or spa includes a controller configured to analyze input related to a pool system and define a future cleaning cycle comprising a trigger based on the input.

According to various embodiments, a method includes receiving feedback from a user after a cleaning cycle with an APC, and adapting at least one cleaning parameter of a future cleaning cycle based on the received feedback.

According to certain embodiments, non-transitory computer readable medium includes instructions, which when executed by a processor is configured to cause the processor to: analyze input related to a pool system, and define a future cleaning cycle comprising a trigger as a cycle parameter based on the input.

According to various embodiments, non-transitory computer readable medium includes instructions, which when executed by a processor is configured to cause the processor to: automatically schedule cleaning cycles by defining a future cleaning cycle comprising at least one cycle parameter, wherein the at least one cycle parameter of the future cleaning cycle is defined based on one or more inputs about a pool system and/or the APC.

According to some embodiments, non-transitory computer readable medium includes instructions, which when executed by a processor is configured to cause the processor to: define a future cleaning cycle based on one or more inputs, wherein the one or more inputs comprise one or more of a date from a last cleaning cycle, a weather forecast, user feedback about the last cleaning cycle, pool dirtiness, pool dimensions, pool shape, pool material, filter status, motor energy consumption, a future pool usage, or battery capacity, and wherein defining the future cleaning cycle comprises defining one or more of a trigger for starting the future cleaning cycle, a date, a cycle duration, a cleaning pattern, or a trigger for ending the future cleaning cycle.

Various implementations described herein can include additional systems, methods, features, and advantages, which cannot necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims.

### BRIEF DESCRIPTION OF THE DRAWINGS

The specification makes reference to the following appended figures, in which use of like reference numerals in different figures is intended to illustrate like or analogous components.

FIG. 1 illustrates a pool system according to embodiments.

FIG. 2 illustrates a method according to embodiments.

### DESCRIPTION OF THE INVENTION

Described herein are systems and methods for automatically scheduling, defining, and/or planning a future cleaning cycle for an APC. In certain embodiments, the APC itself will plan the future cleaning cycle without receiving a cleaning order from a user (e.g., without receiving an order through a button, a remote, an application, or a scheduler set previously by the user). The systems and methods described herein may allow for the pool system to keep the pool or spa clean by itself without relying on an order from the user as traditionally required. Various other benefits and advantages may be realized with the systems and methods provided herein, and the aforementioned advantages should not be considered limiting.

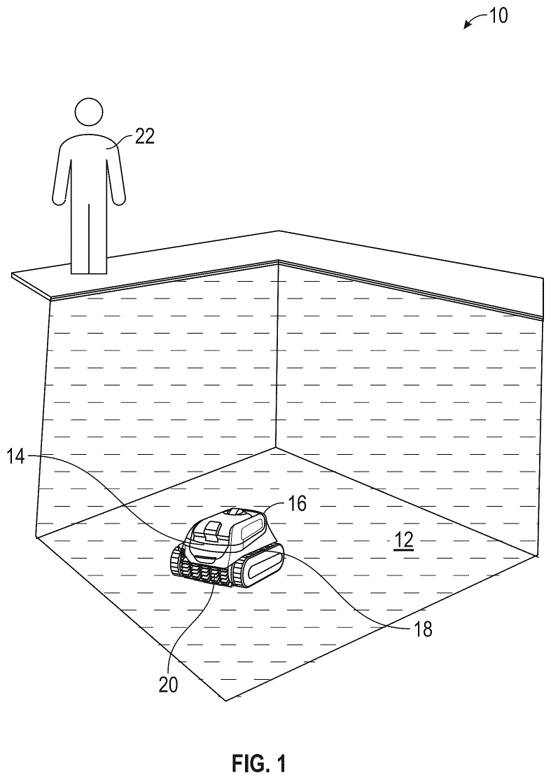

FIG. 1 illustrates an example of a pool system 10 according to various embodiments. The pool system 10 generally includes a pool or spa 12 and an APC 14. The APC 14 generally includes a body 16, one or more motive elements 18, and one or more cleaning devices (including, but not limited to, a scrubber brush 20). A motor, pump, filter, one or more batteries, and various other features may be provided on or within the APC 14 as desired. In various embodiments, a controller (e.g., processor and/or memory), an accelerometer, communication modules (e.g., an antenna, sensor, lights, speakers, etc.), combinations thereof, and/or other features and devices as desired may be included on the APC 14. Other non-limiting examples of APCs 14 may include those described in U.S. Pat. No. 10,316,534, U.S. Pat. No. 9,488,154, U.S. Pat. No. 8,578,538, and U.S. Patent Publication No. 2014/0303810, all of which are hereby incorporated by reference in their entireties. In some embodiments, the APC 14 may be operable in an “auto” mode, in which the APC 14 automatically plans or schedules cleaning cycles by itself as discussed in detail below, or an “order” mode, in which the APC 14 performs a cleaning cycle responsive to a cleaning order (e.g., through a button, a remote, an application, or a scheduler set previously by a user 22). In other embodiments, the APC 14 need not have an order mode, and/or the APC 14 may be operable in other modes as desired.

In various embodiments, in the auto mode, the APC 14 (e.g., the controller of the APC 14) may define a future cleaning cycle without receiving a cleaning order from the user 22. In certain embodiments, the APC 14 may take into account one or more inputs such that the future cleaning cycle is defined based on the one or more inputs. The one or more inputs may be received by and/or determined by the APC 14, and may include various information such as information about a pool system, information about the APC 14, etc. As non-limiting examples, the one or more inputs may include a date from last cleaning cycle, a weather forecast, user feedback about a last cleaning cycle or an upcoming pool usage, a pool dirtiness, pool dimensions, pool shapes, a pool material, a filter status or filling level, part wearing on the APC 14, motor energy consumption of the APC 14, and/or battery capacity of the APC 14, among others.

In some embodiments, the APC 14 may determine and/or obtain the input information itself. As a non-limiting example, the APC 14 may perform a collection operation and analysis of debris to evaluate a pool dirtiness level. As a further non-limiting example, the APC 14 may determine input information using one or more sensors onboard the APC 14. As non-limiting examples, the APC 14 may include one or more sensors or cameras for performing water analysis (e.g., measuring pH, salinity, turbidity, etc.), measuring water temperature, measuring air temperature, measuring a pool coverage rate, detecting a movement, measuring a dimension and/or shape of the pool, determining a pool material, determining a filter status, determining a status of a component of the APC 14, measuring energy consumption of the motor of the APC 14, measuring a battery capacity, etc. Additionally, or alternatively, the APC 14 may receive the input information from another source and/or the user. As a non-limiting example, the APC may receive a weather forecast from a weather forecasting service. As another non-limiting example, the APC 14 may receive user feedback about a past cleaning cycle from the user through an application on a user device. As a further non-limiting example, the user may provide a pool dirtiness level, user localization information (e.g., when the user leaves his work for home), future planned usage of the pool, and/or user working information to the APC 14 through an application. The aforementioned examples of inputs and/or how the APC 14 obtains the one or more inputs are for illustrative purposes only and should not be considered limiting.

In various embodiments, based on the input information, the APC 14 may define a future cleaning cycle for the APC 14. In certain embodiments, the APC 14 may define one or more cycle parameters of the future cleaning cycle based on the input information. Non-limiting examples of the one or more cycle parameters that may be defined based on the input information include, but are not limited to, a trigger for starting the future cleaning cycle, a date of the future cleaning cycle, a cycle duration of the future cleaning cycle, a cleaning pattern of the future cleaning cycle, and/or a trigger for ending the future cleaning cycle. As non-limiting examples, the APC 14 may define a trigger for starting and/or ending the future cleaning cycle to be one or more of a date, a weather event, a solar event (sunrise or sunset), a movement detection in the pool (to launch cycle after a pool party for example), a water analysis event, an air temperature, a water temperature, a cycle duration, pool dirtiness level, a pool coverage rate, a user working time, and/or a user localization event (user leaves his work for example), among others.

In certain embodiments, after defining the future cleaning cycle, the APC 14 may monitor various data for the trigger event. The data may be obtained by the APC 14 itself and/or the APC 14 may receive the data from other sources as discussed previously. As non-limiting examples, the APC 14 may monitor weather information, solar information, movement within the pool or spa 12, water characteristics, air temperatures, water temperatures, cycle durations, pool dirtiness levels, pool coverage rate, user working time, user localization event, etc. for the trigger event, and may initiate the cleaning cycle based on the detection of the trigger event. Similarly, the APC 14 may monitor data for the trigger for ending the future cleaning cycle, and may stop the future cleaning cycle upon detection of such a trigger.

In various embodiments, after defining the future cleaning cycle, the APC 14 optionally may provide the future cleaning cycle to the user 22. In such embodiments, the future cleaning cycle may be displayed on the APC 14 itself and/or provided to the user 22 via an application on a remote device, a user interface on a remote device, and/or as otherwise desired. Optionally, the user may provide supplemental input after the future cleaning cycle has been defined by the APC 14. As a non-limiting example, the supplemental input may include a “no cleaning time” or desired time during which no cleaning cycle is performed, user working times, user localization events, pool usage information, and/or other supplemental information as desired. In certain embodiments, the APC 14 may modify the future cleaning cycle based on the supplemental input (e.g., a modified future cleaning cycle is defined by the APC 14). As a non-limiting example, the APC 14 may initially automatically define a future cleaning cycle, and the user may provide a no cleaning time as supplemental information. Based on the receipt of this supplemental information, the APC 14 may modify the future cleaning cycle such that the future cleaning cycle is not performed during the no cleaning time. Various other types of supplemental information may be provided to and/or determined by the APC 14 that the APC 14 may use to modify the previously defined future cleaning cycle.

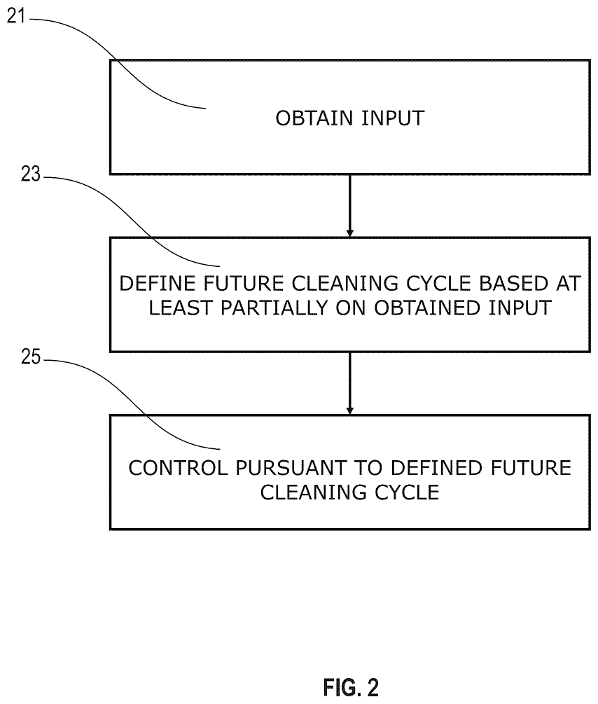

FIG. 2 illustrates a method of controlling the one or more components of the pool system 10 according to embodiments. In certain embodiments, the method of FIG. 2 may be utilized by equipment of the pool system 10, such as but not limited to the APC 14, to automatically schedule cleaning cycles and/or other cleaning operations.

In a block 21, the method includes obtaining and/or receiving one or more input related to the pool system 10. Inputs in block 21 may include, but is not limited to, a date from last cleaning cycle, a weather forecast, user feedback about a last cleaning cycle or an upcoming pool usage, a pool dirtiness, pool dimensions, pool shapes, a pool material, a filter status or filling level, part wearing on the APC 14, motor energy consumption of the APC 14, and/or battery capacity of the APC 14, among others.

In certain embodiments, the block 21 optionally includes receiving and/or obtaining a cleaning order. In such embodiments, receiving and/or obtaining the cleaning order may include, but is not limited to, receiving the cleaning order through a button or user interface on the APC 14, via a remote, via an application running on a remote and/or user device, and/or via a schedule previously set by a user, and/or other input from a user as desired. Additionally, or alternatively, block 21 includes the APC 14 automatically determining and/or obtaining the input itself. As non-limiting examples, block 21 may include performing a collection operation and analysis of debris to evaluate a pool dirtiness level. As a further non-limiting example, block 21 may include determining input information using one or more sensors onboard the APC 14, such as but not limited to one or more sensors or cameras for performing water analysis (e.g., measuring pH, salinity, turbidity, etc.), measuring water temperature, measuring air temperature, measuring a pool coverage rate, detecting a movement, measuring a dimension and/or shape of the pool, determining a pool material, determining a filter status, determining a status of a component of the APC 14, measuring energy consumption of the motor of the APC 14, measuring a battery capacity, etc. Additionally, or alternatively, in block 21, the APC 14 may receive the input information from another source and/or the user. As a non-limiting example, the APC may receive a weather forecast from a weather forecasting service. As another non-limiting example, the APC 14 in block 21 may receive user feedback about a past cleaning cycle from the user through an application on a user device. As a further non-limiting example, the user may provide a pool dirtiness level, user localization information (e.g., when the user leaves his work for home), future planned usage of the pool, and/or user working information to the APC 14 through an application. The aforementioned examples of inputs and/or how the APC 14 obtains the one or more inputs in block 21 are for illustrative purposes only and should not be considered limiting.

In a block 23, the method includes defining a future cleaning cycle for the APC 14 based on the input information obtained in block 21. In some non-limiting examples, block 23 may include defining one or more cycle parameters of the future cleaning cycle based on the input information. Non-limiting examples of the one or more cycle parameters that may be defined based on the input information include, but are not limited to, a trigger for starting the future cleaning cycle, a date of the future cleaning cycle, a cycle duration of the future cleaning cycle, a cleaning pattern of the future cleaning cycle, and/or a trigger for ending the future cleaning cycle. As non-limiting examples, in block 23, the APC 14 may define a trigger for starting and/or ending the future cleaning cycle to be one or more of a date, a weather event, a solar event (sunrise or sunset), a movement detection in the pool (to launch cycle after a pool party for example), a water analysis event, an air temperature, a water temperature, a cycle duration, pool dirtiness level, a pool coverage rate, a user working time, and/or a user localization event (user leaves his work for example), among others.

In certain embodiments, after defining the future cleaning cycle in block 23, the APC 14 may monitor various data for the trigger event, and in a block 25, may initiate the future cleaning cycle. The data may be obtained by the APC 14 itself and/or the APC 14 may receive the data from other sources as discussed previously. As non-limiting examples, the APC 14 may monitor weather information, solar information, movement within the pool or spa 12, water characteristics, air temperatures, water temperatures, cycle durations, pool dirtiness levels, pool coverage rate, user working time, user localization event, etc. for the trigger event, and may initiate the cleaning cycle based on the detection of the trigger event in block 25. Similarly, the APC 14 may monitor data for the trigger for ending the future cleaning cycle, and may stop the future cleaning cycle upon detection of such a trigger in block 25.

In various embodiments, after defining the future cleaning cycle in block 23, the APC 14 optionally may provide the future cleaning cycle to the user 22. In such embodiments, the future cleaning cycle may be displayed on the APC 14 itself and/or provided to the user 22 via an application on a remote device, a user interface on a remote device, and/or as otherwise desired. Optionally, the user may provide supplemental input after the future cleaning cycle has been defined by the APC 14. As a non-limiting example, the supplemental input may include a “no cleaning time” or desired time during which no cleaning cycle is performed, user working times, user localization events, pool usage information, and/or other supplemental information as desired. In certain embodiments, the APC 14 may modify the future cleaning cycle based on the supplemental input (e.g., a modified future cleaning cycle is defined by the APC 14). As a non-limiting example, the APC 14 may initially automatically define a future cleaning cycle, and the user may provide a no cleaning time as supplemental information. Based on the receipt of this supplemental information, the APC 14 may modify the future cleaning cycle such that the future cleaning cycle is not performed during the no cleaning time. Various other types of supplemental information may be provided to and/or determined by the APC 14 that the APC 14 may use to modify the previously defined future cleaning cycle.

Various other methods may be employed using the systems described herein, and the above method should not be considered limiting.

Exemplary concepts or combinations of features of the invention may include:
A. A method of automatically scheduling cleaning cycles for an APC, the method comprising analyzing, by the APC, input related to a pool system, and defining, by the APC, a future cleaning cycle comprising a trigger as a cycle parameter based on the input.
B. The method of any preceding or subsequent statement or combination of statements, further comprising causing the APC to perform the future cleaning cycle based on an occurrence of the trigger.
C. The method of any preceding or subsequent statement or combination of statements, further comprising defining an additional cycle parameter for the future cleaning cycle based on the input.
D. The method of any preceding or subsequent statement or combination of statements, wherein the additional cycle parameter comprises a date, cycle duration, cleaning pattern, and/or trigger for ending the future cleaning cycle.
E. The method of any preceding or subsequent statement or combination of statements, wherein the input comprises at least one of a date from a last cleaning cycle, a weather forecast, user feedback about the last cleaning cycle, pool dirtiness, pool dimensions, pool shape, pool material, filter status, motor energy consumption, pool usage, or battery capacity.
F. The method of any preceding or subsequent statement or combination of statements, further comprising receiving the input from a user.
G. The method of any preceding or subsequent statement or combination of statements, further comprising receiving the input from at least one sensor or camera.
H. The method of any preceding or subsequent statement or combination of statements, wherein the at least one sensor or camera is onboard the APC.
I. The method of any preceding or subsequent statement or combination of statements, further comprising providing the defined future cleaning cycle to a user.
J. The method of any preceding or subsequent statement or combination of statements, further comprising receiving supplemental input from a user after defining the future cleaning cycle and modifying the future cleaning cycle based on the supplemental input.
K. The method of any preceding or subsequent statement or combination of statements, wherein the supplemental input comprises a time period without cleaning.
L. The method of any preceding or subsequent statement or combination of statements, wherein the trigger for starting the future cleaning cycle comprises at least one of a date, a weather event, a solar event, a movement detection in the pool, a water analysis event, an air temperature, a water temperature, a cycle duration, a pool dirtiness level, a pool coverage rate, a user working time, a pool usage event, or a user localization event.
M. A method of automatically scheduling cleaning cycles for an APC, the method comprising defining a future cleaning cycle comprising at least one cycle parameter, wherein the at least one cycle parameter of the future cleaning cycle is defined based on one or more inputs about a pool system and/or the APC.
N. The method according to statement M, further comprising any preceding or subsequent statement or combination of statements.
O. A method comprising automatically scheduling a future cleaning cycle for an APC without receiving a cleaning order from a user.
P. A method comprising defining a future cleaning cycle based on one or more inputs, wherein the one or more inputs comprise one or more of a date from a last cleaning cycle, a weather forecast, user feedback about the last cleaning cycle, pool dirtiness, pool dimensions, pool shape, pool material, filter status, motor energy consumption, a future pool usage, or battery capacity, and wherein defining the future cleaning cycle comprises defining one or more of a trigger for starting the future cleaning cycle, a date, a cycle duration, a cleaning pattern, or a trigger for ending the future cleaning cycle.
Q. An APC for a swimming pool or spa, the APC comprising a controller configured to automatically define a future cleaning cycle for the APC without receiving a cleaning order from a user.
R. An APC for a swimming pool or spa, the APC comprising a controller configured to analyze input related to a pool system and define a future cleaning cycle comprising a trigger based on the input.
S. A method comprising receiving feedback from a user after a cleaning cycle with an APC, and adapting at least one cleaning parameter of a future cleaning cycle based on the received feedback.
T. The method of any preceding or subsequent statement or combination of statements, wherein the at least one cleaning parameter comprises a duration, cleaning area, or cleaning pattern.
U. A non-transitory computer readable medium comprising instructions, which when executed by a processor is configured to cause the processor to:
   i. analyze input related to a pool system; and
   ii. define future cleaning cycle comprising a trigger as a cycle parameter based on the input.
V. A non-transitory computer readable medium comprising instructions, which when executed by a processor is configured to cause the processor to: automatically schedule cleaning cycles by defining a future cleaning cycle comprising at least one cycle parameter, wherein the at least one cycle parameter of the future cleaning cycle is defined based on one or more inputs about a pool system and/or the APC.
W. A non-transitory computer readable medium comprising instructions, which when executed by a processor is configured to cause the processor to: define a future cleaning cycle based on one or more inputs, wherein the one or more inputs comprise one or more of a date from a last cleaning cycle, a weather forecast, user feedback about the last cleaning cycle, pool dirtiness, pool dimensions, pool shape, pool material, filter status, motor energy consumption, a future pool usage, or battery capacity, and wherein defining the future cleaning cycle comprises defining one or more of a trigger for starting the future cleaning cycle, a date, a cycle duration, a cleaning pattern, or a trigger for ending the future cleaning cycle.

These examples are not intended to be mutually exclusive, exhaustive, or restrictive in any way, and the invention is not limited to these example embodiments but rather encompasses all possible modifications and variations within the scope of any claims ultimately drafted and issued in connection with the invention (and their equivalents). For avoidance of doubt, any combination of features not physically impossible or expressly identified as non-combinable herein may be within the scope of the invention. Further, although applicant has described devices and techniques for use principally with APCs, persons skilled in the relevant field will recognize that the present invention conceivably could be employed in connection with other objects and in other manners. Finally, references to “pools” and “swimming pools” herein may also refer to spas or other water containing vessels used for recreation, training, or therapy and for which cleaning of debris is needed or desired.

That which is claimed:

1. An automatic swimming pool cleaner (APC) for a swimming pool or spa, the APC comprising a controller configured to:
analyze input related to a pool system; and
define a future cleaning cycle comprising a trigger based on the input, wherein the input comprises at least one of a date from a last cleaning cycle, a weather forecast, user feedback about the last cleaning cycle, pool dirtiness, pool dimensions, pool shape, pool material, filter status, motor energy consumption, pool usage, or battery capacity.

2. The APC of claim 1, wherein the APC is configured to define a future cleaning cycle for the APC without receiving a cleaning order from a user.

3. The APC of claim 1, wherein the APC is configured to perform the future cleaning cycle based on occurrence of the trigger.

4. The APC of claim 1, wherein the trigger for starting the future cleaning cycle comprises at least one of a date, a weather event, a solar event, a movement detection in the pool, a water analysis event, an air temperature, a water temperature, a cycle duration, a pool dirtiness level, a pool coverage rate, a user working time, a pool usage event, or a user localization event.

5. A method of automatically scheduling cleaning cycles for automatic swimming pool cleaner (APC), the method comprising analyzing, by the APC, input related to a pool system, and defining, by the APC, a future cleaning cycle comprising a trigger as a cycle parameter based on the input.

6. The method of claim 5, further comprising causing the APC to perform the future cleaning cycle based on an occurrence of the trigger.

7. The method of claim 5, further comprising defining an additional cycle parameter for the future cleaning cycle based on the input.

8. The method of claim 7, wherein the additional cycle parameter comprises a date, cycle duration, cleaning pattern, and/or trigger for ending the future cleaning cycle.

9. The method of claim 5, wherein the input comprises at least one of a date from a last cleaning cycle, a weather forecast, user feedback about the last cleaning cycle, pool dirtiness, pool dimensions, pool shape, pool material, filter status, motor energy consumption, pool usage, or battery capacity.

10. The method of claim 5, further comprising receiving the input from a user.

11. The method of claim 5, further comprising receiving the input from at least one sensor or camera.

12. The method of claim 5, further comprising providing the defined future cleaning cycle to a user.

13. The method of claim 5, further comprising receiving supplemental input from a user after defining the future cleaning cycle and modifying the future cleaning cycle based on the supplemental input.

14. The method of claim 5, wherein the trigger for starting the future cleaning cycle comprises at least one of a date, a weather event, a solar event, a movement detection in the pool, a water analysis event, an air temperature, a water temperature, a cycle duration, a pool dirtiness level, a pool coverage rate, a user working time, a pool usage event, or a user localization event.

15. A non-transitory computer readable medium comprising instructions, which when executed by a processor, are configured to cause the processor to: automatically schedule cleaning cycles by defining a future cleaning cycle comprising at least one cycle parameter, wherein the at least one cycle parameter of the future cleaning cycle is defined based on one or more inputs about a pool system and/or the automatic swimming pool cleaner.

16. The non-transitory computer readable medium of claim 15, wherein the one or more inputs comprise one or more of a date from a last cleaning cycle, a weather forecast, user feedback about the last cleaning cycle, pool dirtiness, pool dimensions, pool shape, pool material, filter status, motor energy consumption, a future pool usage, or battery capacity, and wherein defining the future cleaning cycle comprises defining one or more of a trigger for starting the future cleaning cycle, a date, a cycle duration, a cleaning pattern, or a trigger for ending the future cleaning cycle.

17. The non-transitory computer readable medium of claim 15, wherein the instructions further comprise instructions, which when executed by a processor, are configured to cause the processor to: perform the future cleaning cycle based on an occurrence of the trigger.

18. The non-transitory computer readable medium of claim 15, wherein the instructions further comprise instructions, which when executed by a processor, are configured to cause the processor to: define an additional cycle parameter for the future cleaning cycle based on the input, wherein the additional cycle parameter comprises a date, cycle duration, cleaning pattern, and/or trigger for ending the future cleaning cycle.

19. The non-transitory computer readable medium of claim 15, wherein the instructions further comprise instructions, which when executed by a processor, are configured to cause the processor to:
a. receive the input from a user; and/or
b. receive the input from at least one sensor or camera.

20. The non-transitory computer readable medium of claim 15, wherein the trigger for starting the future cleaning cycle comprises at least one of a date, a weather event, a solar event, a movement detection in the pool, a water analysis event, an air temperature, a water temperature, a cycle duration, a pool dirtiness level, a pool coverage rate, a user working time, a pool usage event, or a user localization event.
